(19) United States
(12) Patent Application Publication
(10) Pub. No.: US 2009/0019306 A1
(43) Pub. Date: Jan. 15, 2009

(54) Protecting tag information in a multi-level cache hierarchy

(76) Inventors: Herbert Hum, Portland, OR (US); Rajagopal K. Narayanan, Portland, OR (US)

Correspondence Address: TROP PRUNER & HU, PC, 1616 S. VOSS ROAD, SUITE 750, HOUSTON, TX, 77057-2631, US

(21) Appl. No.: 11/827,197

(22) Filed: Jul. 11, 2007

(51) Int. Cl. G06F 11/00

(52) U.S. Cl. 714/2; 714/E11.001

(57) ABSTRACT

In one embodiment, the present invention includes a shared cache memory that is inclusive with other cache memories coupled to it. The shared cache memory includes error correction logic to correct an error present in a tag array of one of the other cache memories and to provide corrected tag information to replace a tag entry in the tag array including the error. Other embodiments are described and claimed.

### BACKGROUND

Many systems include one or more cache memories to temporarily store data in closer relation to a processor in which the data will be used. In this way, decreased data retrieval times can be realized by the processor, improving performance. Multiple levels of cache memory may be present in certain systems. These cache levels may include a lowest level cache memory that can be present within a processor, as well as a so-called mid-level cache memory that also can be present within the processor. Additional levels of cache memories, either within the processor or closely coupled thereto, may further be present in various systems.

In some systems, multiple levels of cache memory may be implemented as an inclusive cache hierarchy. In an inclusive cache hierarchy, one of the cache memories (i.e., a lower-level cache memory) includes a subset of data contained in another cache memory (i.e., an upper-level cache memory). Cache hierarchies may improve processor performance, as they allow a smaller cache having a relatively fast access speed to contain frequently used data. In turn, a larger cache having a slower access speed than the smaller cache stores less-frequently used data (as well as copies of the data in the lower-level cache). Typically, the lower-level cache memories of such an inclusive cache hierarchy are smaller than the higher-level cache memories.

### BRIEF DESCRIPTION OF THE DRAWINGS

FIG. 1 is a block diagram of a processor in accordance with one embodiment of the present invention.

FIG. 2 is a flow diagram of a method in accordance with one embodiment of the present invention.

FIG. 3 is a block diagram of a processor core in accordance with one embodiment of the present invention.

FIG. 4 is a block diagram of a multiprocessor system in accordance with an embodiment of the present invention.

### DETAILED DESCRIPTION

In an inclusive cache hierarchy, tag information in a lower level cache may be error protected using information in a higher level cache of the inclusive cache hierarchy. That is, in various embodiments, a smaller amount of logic may be provided in a lower cache memory, e.g., to provide for error detection capabilities for tag information, without the need for providing error correction logic within the lower level cache. Instead, such error correction logic may be present in the higher level cache, resulting in area and power savings. As such, there is no need for error correction coding (ECC) logic on a per tag way basis.

For example, in a strictly inclusive shared cache memory having three cache levels including a lowest cache level, a mid-level cache and a last-level cache (LLC), ECC logic may be present in the LLC, with only error detection logic, e.g., parity protection, provided for a matching way of the mid-level cache.

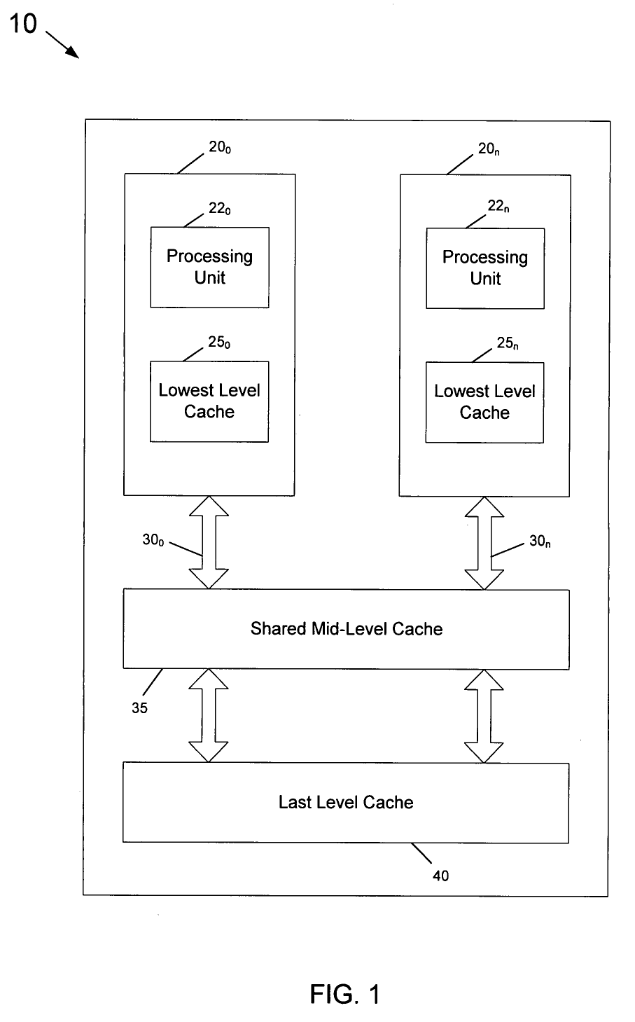

Referring now to FIG. 1, shown is a block diagram of a processor in accordance with one embodiment of the present invention. As shown in FIG. 1, processor 10 may be a multi-core processor including a plurality of processor cores 20₀-20ₙ (generically core 20). As shown in FIG. 1, each core may include at least one level of a cache hierarchy. Specifically, as shown in FIG. 1, each core 20 may include a lowest-level cache 25₀-25ₙ (generically cache 25). In one embodiment, cache 25 may correspond to a level one (L1) cache, although the scope of the present invention is not so limited. As further shown in FIG. 1, each core 20 further includes a processing unit 22₀-22ₙ (generically processing unit 22).

Processor 10 may further include a mid-level cache (MLC) 35, which may be a level two (L2) cache, and which is a higher-level cache that includes copies of the data present in the lowest-level caches. As shown in FIG. 1, each core 20 may be coupled to MLC 35 via a link 30₀-30ₙ (generically link 30) so that MLC 35 acts as a shared memory. In turn, MLC 35 is coupled to a last-level cache 40. Although shown with this hierarchy in the embodiment of FIG. 1, understand that an LLC may be external to a processor and further, more or fewer cache memories may form a cache hierarchy.

In various embodiments, processor 10 may have an inclusive cache hierarchy. For example, in the inclusive cache hierarchy of FIG. 1, cache 25 may include a subset of the data within cache 35, while in turn cache 35 may include a subset of the data in cache 40. To maintain cache coherency upon an eviction of a cache line from last-level cache 40, corresponding cache lines in a given mid-level cache 35 and lowest-level cache 25 may also be evicted, in some embodiments.

In various embodiments, processor 10 may be a multi-threaded multiprocessing chip for use in various systems such as desktop, portable and server systems. Embodiments may be particularly adapted for use where data integrity is to be maintained. Thus processor 10 of FIG. 1 may be one of multiple processing nodes within a system. In one such embodiment, four processor cores 20 may be present with a shared mid-level cache. In various embodiments, both the tag and data in this mid-level cache may be protected. In some implementations, the mid-level cache may be a M-way N-set associative cache memory organized as a plurality of banks of data and tag arrays and logic for error correction coding (ECC) of the data arrays. Note that a dedicated tag bank may be associated with each data bank to generate match signals. If ECC logic were provided for each tag array, an implementation would consume a significant amount of area and power, as all M-ways would be enabled at the same time. Accordingly, embodiments may forgo ECC logic within the tag arrays of such a mid-level cache. Instead, as described below, error correction may be provided for these tag arrays using information present in a higher level cache.

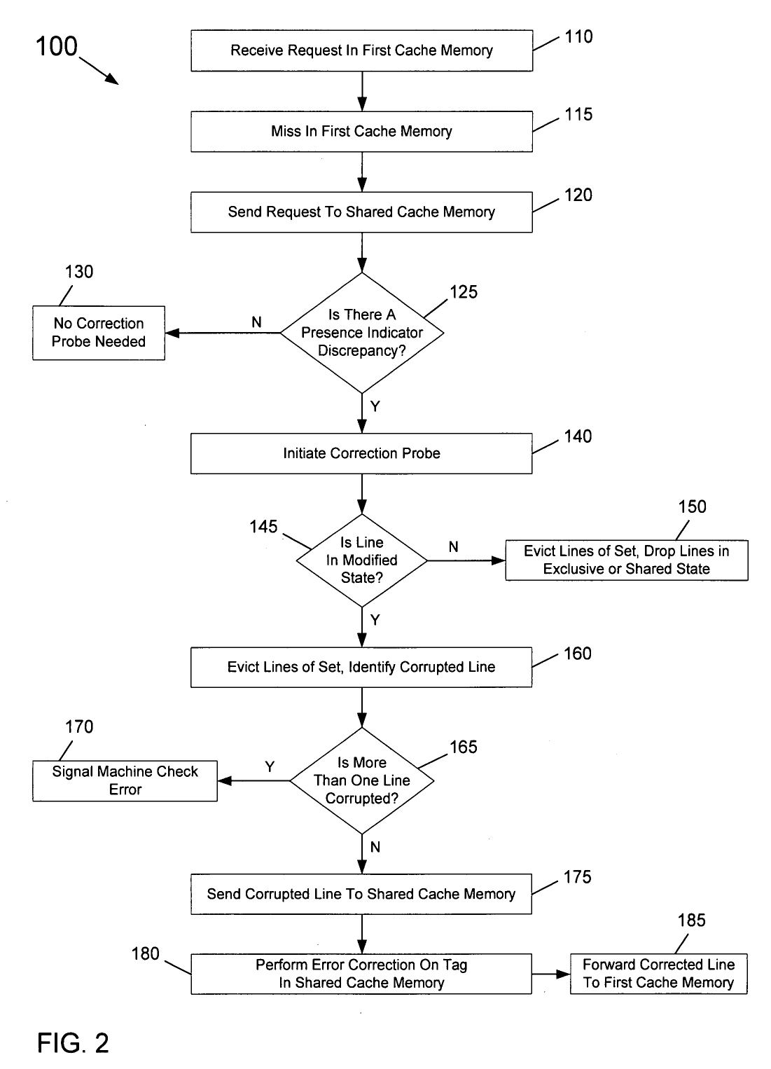

Referring now to FIG. 2, shown is a flow diagram of a method in accordance with one embodiment of the present invention. As shown in FIG. 2, method 100 may be used to handle errors in tag information in a tag array of a lower level cache using error correction logic of a higher level cache. As shown in FIG. 2, method 100 may begin by receiving a request for data in a first cache memory (block 110). For example, such a request may be received in a second level cache (i.e., an L2) of a three-level cache hierarchy including a first level cache (i.e., an L1 cache), the L2 cache, and a third level cache (i.e., an L3 cache), which may be a shared cache memory. Note that in such an embodiment the L1 and L2 caches may be private caches associated with a given processor core while the L3 cache may be a shared cache memory.

Still referring to FIG. 2, a miss may occur for the requested data in the first cache memory (i.e., at block 115). Such miss may be because the requested data is not present in the first cache memory or the miss may be a result of a tag error in which the requested data is present in the first cache memory, but a tag match does not occur due to the tag error.

Accordingly, as shown in FIG. 2, the request may be sent to a shared cache memory (i.e., the L3 cache) (block 120). There, it may be determined if there is a presence indicator discrepancy (diamond 125). That is, the L3 cache may maintain a presence indicator for each line specifying which first cache memory (i.e., of multiple such memories each associated with a given core) includes a copy of the line. In different embodiments, different manners may be used to maintain such a presence indicator. If no such presence indicator discrepancy is determined, control passes to block 130, where no correction probe is needed. Accordingly, a process flow in which the requested line is loaded into the first cache memory may be performed.

Still referring to FIG. 2, if a discrepancy with regard to the presence indicator is determined, control passes to block 140. At block 140 a correction probe may be initiated, for example, by the shared cache memory. The correction probe may cause a correction signal to be sent to the cache with the potential tag error. This correction signal may be sent with an accompanying address to enable the first cache memory to access the set associated with that address. In turn, the first cache memory may evict the various ways associated with the set.

Prior to such eviction, it may be determined whether the particular cache line associated with the address information is in a modified state (diamond 145). For example, implementations may be used in a cache architecture that incorporates a cache coherency protocol such as a modified (M), exclusive (E), shared (S), and invalid (I) (collectively, MESI) protocol, although the scope of the present invention is not limited in this regard.

Still referring to FIG. 2, if the line is not in the modified state, control passes to block 150, where lines of the set may be evicted from the first cache memory. Accordingly, the various lines in an E or S state may be dropped. As these lines do not include modified data, there is no need to write these lines back to the shared cache memory.

Referring still to FIG. 2, if instead it is determined that the given line is in a modified state, control passes to block 160. There, the lines of the corresponding set may be evicted. Furthermore, error detection logic within the first cache memory may identify the corrupted line. For example, parity information associated with the tag of each of the evicted lines may be checked to determine whether an error exists. Thus in block 160, an evicted line from the first cache memory that has no tag parity error and hits in the shared cache memory is deemed to be correct. Eventually a line with a tag parity error may surface and the data contents of that line may be sent to the shared cache memory along with the address that came with the correction probe signal. Based on such processing, control passes to diamond 165, where it may be determined whether there is more than one corrupted line in the set or no line with a parity error is detected after the evictions. If so, a machine check error may be generated (block 170). Note also that a machine check error may be generated responsive to a write back invalidate instruction if a tag parity error occurs for a line in the modified state. If instead, only one corrupted line is indicated, control passes to block 175 where the corrupted line may be sent to the shared cache memory.

In the shared cache memory, error correction may be performed on the tag associated with the given line. That is, because the shared cache memory includes ECC logic, the error may be corrected. Then when the error is corrected, the corrected line may be forwarded back to the first cache memory (block 185). Of course, from there the first cache memory may forward the line along to a lowest level cache, e.g., a L1 cache, and from there on to a processor core. Alternately, the first cache memory may directly send the corrected line to the processor core, in some embodiments.

Thus in various embodiments, an error detection mechanism (e.g., parity protection) may be deployed for only a matching way within a tag array of a given cache level. Since correction logic is not needed inside this tag array and the error detection logic is not replicated on a per way basis, area and power saving may be substantial, in some embodiments.

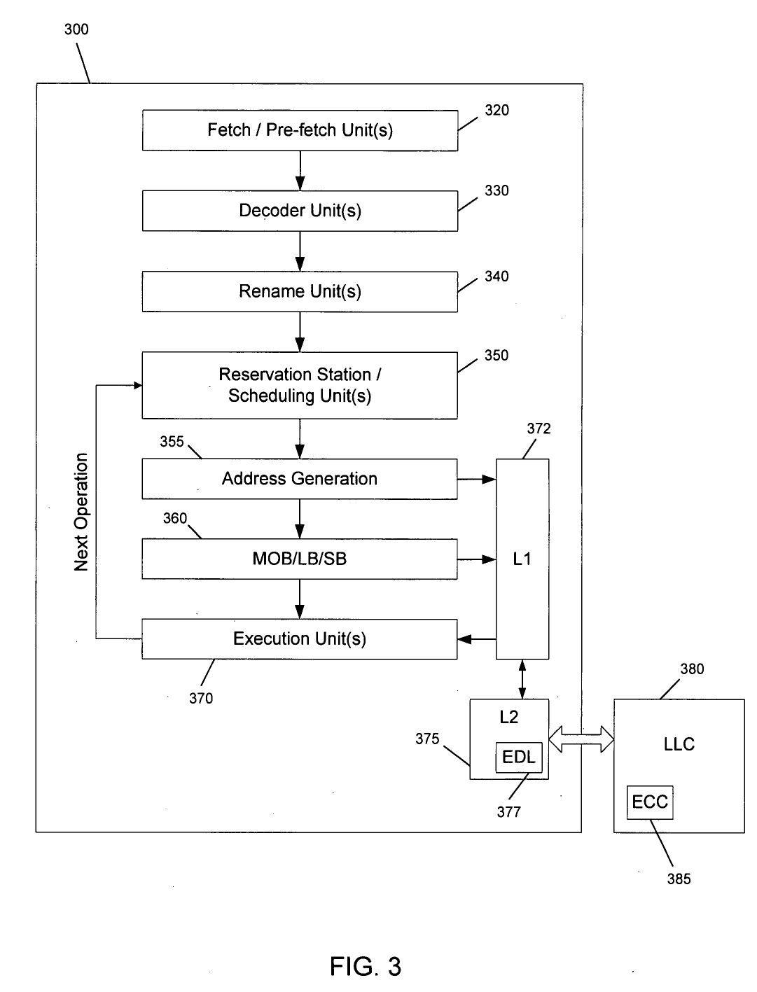

Referring now to FIG. 3, shown is a block diagram of a processor core in accordance with one embodiment of the present invention. The core illustrated in FIG. 3 may execute instructions or sub-instructions (e.g., micro-operations, or “uops”) in program order (“in-order execution”) or in a different order than program order (“out-of-order execution”). Moreover, the core illustrated in FIG. 3 may be included with other cores in a multi-core processor or in a single-core processor.

As shown in FIG. 3, processor 300 may be a multi-stage pipeline processor. Note that while shown at a high level in FIG. 3 as including six stages, it is to be understood that the scope of the present invention is not limited in this regard, and in various embodiments more or fewer than six such stages may be present. As shown in FIG. 3, the pipeline of processor 300 may begin at a front end with an instruction fetch stage 320 in which instructions are fetched from, e.g., an instruction cache or other location.

From instruction fetch stage 320, data passes to an instruction decode stage 330, in which instruction information is decoded, e.g., an instruction is decoded into microoperations (μops). From instruction decode stage 330, data may pass to a register renamer stage 340, where data needed for execution of an operation can be obtained and stored in various registers, buffers or other locations. Furthermore, renaming of registers to associate limited logical registers onto a greater number of physical registers may be performed.

Still referring to FIG. 3, when needed data for an operation is obtained and present within the processor's registers, control passes to a back end stage, namely reservation/scheduling units 350, which may be used to assign an execution unit for performing the operation and provide the data to the execution unit. Addresses may be generated in an address generator unit 355, to which are coupled various storage units 360, such as a memory order buffer (MOB), a store buffer (SB) and a load buffer (LB), which may be in communication with a memory hierarchy. Upon execution in one of or more execution units 370, the resulting information is provided to reservation/scheduling units 350 and buffers 360 until written back, e.g., to lower levels of a memory hierarchy, such as a cache memory, a system memory coupled thereto, or an architectural register file.

More specifically, as shown in FIG. 3, a cache hierarchy may include a L1 cache 372, which in turn is coupled to an L2 cache 375. In turn, L2 cache 375 may be coupled to a LLC 380, which may be a shared cache to which multiple processors adapted similarly to processor 300 may be coupled. As shown in FIG. 3, L2 cache 375 may include error detection logic (EDL) 377 in accordance with an embodiment of the present invention. EDL 377 may be used to detect an error in a tag entry of a tag array. Note that only a single such EDL may be needed for each bank of the tag array, as only a selected way may be processed by EDL 377. While not shown in the embodiment of FIG. 3, understand that data arrays of L2 cache 375 may be protected with ECC logic.

Referring still to FIG. 3, LLC 380 may include ECC logic 385. ECC logic 385 may be used to correct errors in tag entries within a tag array of LLC 380. In various embodiments, such ECC logic may be provided for each bank of the tag array. While shown with this particular implementation in the embodiment of FIG. 3, the scope of the present invention is not limited in this regard.

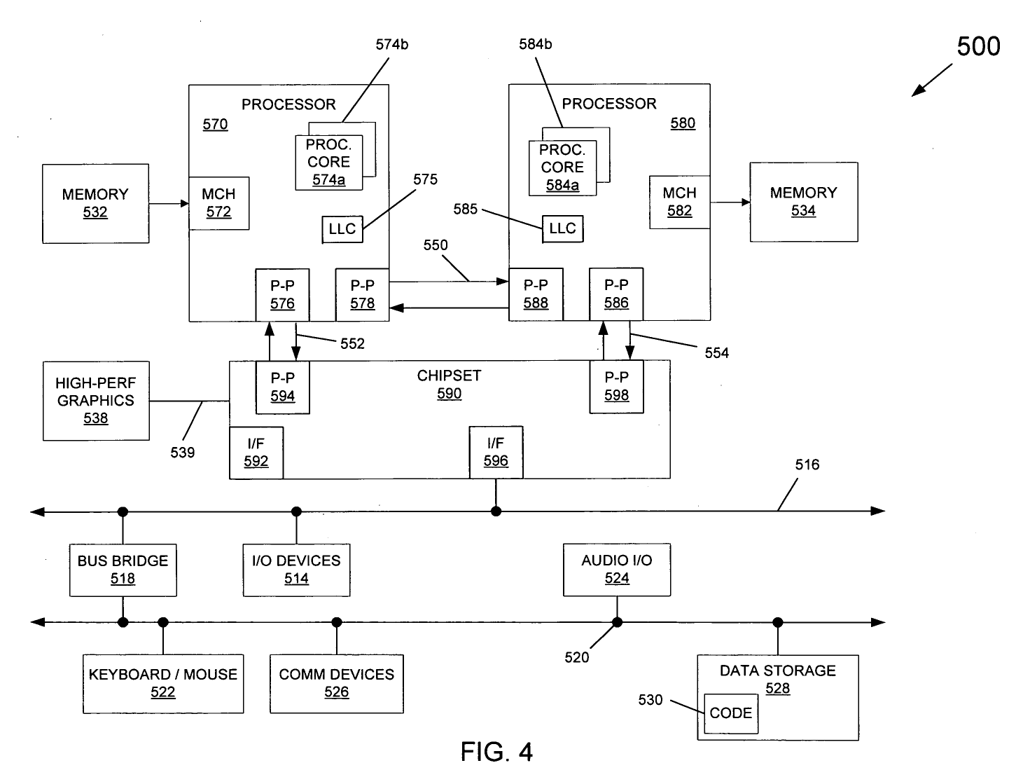

Embodiments may be suited for many different types of platforms. Referring now to FIG. 4, shown is a block diagram of a multiprocessor system in accordance with an embodiment of the present invention. As shown in FIG. 4, multiprocessor system 500 is a point-to-point interconnect system, and includes a first processor 570 and a second processor 580 coupled via a point-to-point interconnect 550. However, in other embodiments the multiprocessor system may be of another bus architecture, such as a multi-drop bus or another such implementation. As shown in FIG. 4, each of processors 570 and 580 may be multi-core processors including first and second processor cores (i.e., processor cores 574a and 574b and processor cores 584a and 584b), although other cores and potentially many more other cores may be present in particular embodiments. While not shown in the embodiment of FIG. 4, the first and second processor cores may each include one or more cache memories. Furthermore, as shown in FIG. 4 a last-level cache memory 575 and 585 may be coupled to each pair of processor cores 574a and 574b and 584a and 584b, respectively, and may provide error correction of tag information in lower level caches when such an error is detected, as described above.

Still referring to FIG. 4, first processor 570 further includes a memory controller hub (MCH) 572 and point-to-point (P-P) interfaces 576 and 578. Similarly, second processor 580 includes a MCH 582 and P-P interfaces 586 and 588. As shown in FIG. 4, MCH's 572 and 582 couple the processors to respective memories, namely a memory 532 and a memory 534, which may be portions of main memory (e.g., a dynamic random access memory (DRAM)) locally attached to the respective processors.

First processor 570 and second processor 580 may be coupled to a chipset 590 via P-P interconnects 552 and 554, respectively. As shown in FIG. 4, chipset 590 includes P-P interfaces 594 and 598. Furthermore, chipset 590 includes an interface 592 to couple chipset 590 with a high performance graphics engine 538 via a bus 539.

As shown in FIG. 4, various I/O devices 514 may be coupled to first bus 516, along with a bus bridge 518 which couples first bus 516 to a second bus 520. In one embodiment, second bus 520 may be a low pin count (LPC) bus. Various devices may be coupled to second bus 520 including, for example, a keyboard/mouse 522, communication devices 526 and a data storage unit 528 which may include code 530, in one embodiment. Further, an audio I/O 524 may be coupled to second bus 520.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
determining in a shared cache memory if an error is present in a tag stored in an entry of a first cache memory coupled to the shared cache memory;
initiating a correction probe from the shared cache memory to the first cache memory if the error is present; and
correcting the error in error correction logic of the shared cache memory and forwarding the corrected tag and corresponding data from the shared cache memory to the first cache memory.

2. The method of claim 1, wherein determining if the error is present comprises determining a hit to an entry in the shared cache memory after a miss in the first cache memory for a corresponding entry, wherein the first cache memory and the shared cache memory are part of an inclusive cache hierarchy and the first cache memory includes a plurality of tag arrays having no error correction logic and the shared cache memory includes a plurality of tag arrays having error correction logic.

3. The method of claim 1, wherein initiating the correction probe comprises sending a correction signal from the shared cache memory to the first cache memory.

4. The method of claim 3, further comprising evicting a plurality of ways of a set in the first cache memory including the error, responsive to the correction probe.

5. The method of claim 4, further comprising identifying one of the plurality of evicted ways including the error and sending information of the corresponding way to the shared cache memory.

6. The method of claim 5, further comprising correcting the error in the shared cache memory and forwarding the error corrected tag and the corresponding way data to the first cache memory from the shared cache memory.

7. The method of claim 6, further comprising forwarding the error corrected tag and the corresponding way data to a processor core coupled to the first cache memory.

8. An apparatus comprising:
a first processor core including a first cache memory having a first data array and a first tag array, wherein the first tag array includes a first logic to detect an error in the first tag array but not correct the error;
a shared cache memory coupled to the first processor core, wherein the shared cache memory is inclusive with the first cache memory and other cache memories coupled to the shared cache memory, the shared cache memory including error correction logic to correct an error in the first tag array and to provide corrected tag information to replace a tag entry in the first tag array including the error.

9. The apparatus of claim 8, further comprising a second processor core including a second cache memory having a second data array and a second tag array, wherein the second tag array includes a second logic to detect an error in the second tag array but not correct the error.

10. The apparatus of claim 8, wherein the shared cache memory is to determine if an error is present in a tag stored in an entry of the first tag array and to initiate a correction probe to the first cache memory if the error is present.

11. The apparatus of claim 10, wherein the shared cache memory is to determine if the error is present when a hit occurs to an entry in the shared cache memory after a miss in the first cache memory for a corresponding entry.

12. The apparatus of claim 11, wherein the first cache memory is to evict a plurality of ways of a set including the error responsive to receipt of the correction probe and to identify one of the plurality of evicted ways including the error and send information of the corresponding way to the shared cache memory.

13. The apparatus of claim 8, wherein the first logic is to detect the error for only a matching way of the first tag array.

14. The apparatus of claim 13, wherein the first data array includes error correction logic and the first tag array does not include error correction logic.
